(19) United States
(12) Patent Application Publication
(10) Pub. No.: US 2005/0284265 A1
(43) Pub. Date: Dec. 29, 2005

(54) Anvil system for pneumatic ratchet wrench

(76) Inventor: David J. Baker, Fort Lawn, SC (US)

Correspondence Address: Schmeiser, Olsen & Watts LLP;Suite 201, 3 Lear Jet Lane, Latham, NY, 12110, US

(21) Appl. No.: 10/878,096

(22) Filed: Jun. 28, 2004

(51) Int. Cl. B25B 13/46

(52) U.S. Cl. 81/57.39; 81/57.3

(57) ABSTRACT

An anvil for use with pneumatic ratchet wrenches that includes the capability for quick, releasing and changing of the anvil from the wrench. An anvil system that includes a coupling mechanism in the wrench that retains the anvil and a wrench and method that employs same is disclosed.

### BACKGROUND OF THE INVENTION

1. Technical Field

The invention relates, in general, to an anvil system and method for use with pneumatic ratchet wrenches. In particular, the present invention relates to a releasably attached anvil system for use with a pneumatic ratchet, a pneumatic ratchet that includes such an anvil system, and a method of use thereof.

2. Related Art

In the art of ratchets and pneumatic ratchets, there is a need for an anvil system that provides greater flexibility and convertibility, including the ability to quickly change the anvil.

### SUMMARY OF THE INVENTION

The present invention offers an anvil wherein the anvil can be changed out quickly.

In a first general aspect, the present invention provides a rotatable anvil adapted for use with a pneumatic ratchet tool comprising:

an anvil having a coupling mechanism for releasable attachment of the anvil to said tool, wherein at least a portion of said coupling mechanism rotates along with said anvil.

In a second general aspect, the present invention provides an anvil system for use with a pneumatic ratchet wrench comprising:

a rotatable anvil, configured to be releasably attachable to said wrench; and

a coupling mechanism, for attaching and releasing said anvil from said wrench, said mechanism being self-contained.

In a third general aspect, the present invention provides a pneumatic ratchet wrench comprising:

a housing

a motor contained with said housing;

a plurality of offset gears in mechanical communication with said motor; and

a rotatable anvil releasably attached to at least one of said plurality of offset gears.

In a fourth general aspect, the present invention provides a method of using an anvil with a pneumatic ratchet wrench comprising:

providing a rotatable anvil;

releasably attaching said anvil to said tool, via a coupling mechanism, wherein at least a portion of said coupling mechanism rotates along with said anvil.

The foregoing and other features and advantages of the invention will be apparent from the following more particular description of embodiments of the invention. It is to be understood that both the foregoing general description and the following detailed description are exemplary, but are not restrictive, of the invention.

### BRIEF DESCRIPTION OF THE DRAWINGS

Some of the embodiments of this invention will be described in detail, with reference to the following figures, wherein like designations denote like members, wherein:

FIG. 1 depicts a side view of a pneumatic ratchet with a sectional view of an embodiment of the anvil system, in accordance with the present invention;

FIG. 2 depicts an exploded perspective view of an embodiment of an anvil and an offset gear, in accordance with the present invention;

FIG. 3A depicts a side sectional view of an embodiment of an anvil, in accordance with the present invention;

FIG. 3B depicts the anvil in FIG. 3A with a release button engaged, in accordance with the present invention;

FIG. 4A depicts a side sectional view of an embodiment of an anvil system, in accordance with the present invention;

FIG. 4B the anvil system in FIG. 4A with a release button engaged and the anvil partially removed from an offset gear, in accordance with the present invention;

FIG. 5 depicts an exploded perspective view of a second embodiment of an anvil and an offset gear, in accordance with the present invention;

FIG. 6A depicts a side sectional view of a second embodiment of an anvil moving into engagement with an offset gear, in accordance with the present invention;

FIG. 6B depicts a side sectional view of the second embodiment of an anvil system, in accordance with the present invention;

FIG. 6C depicts a side sectional view of the second embodiment of an anvil disengaging from the offset gear, in accordance with the present invention; and

FIG. 7 depicts an top sectional view of the second embodiment of the anvil, in accordance with the present invention.

### DETAILED DESCRIPTION OF THE INVENTION

Although certain preferred embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

The present invention offers an improved pneumatic ratchet with an anvil system that allows for the quick changing out of the anvil thereby offering more flexibility and more options for the wrench user. The present invention offers greater flexibility, greater ease of use, and more options, than current pneumatic ratchets do. The term pneumatic ratchet as used herein denotes an air powered hand tool to be used in conjunction with at least one rotating anvil.

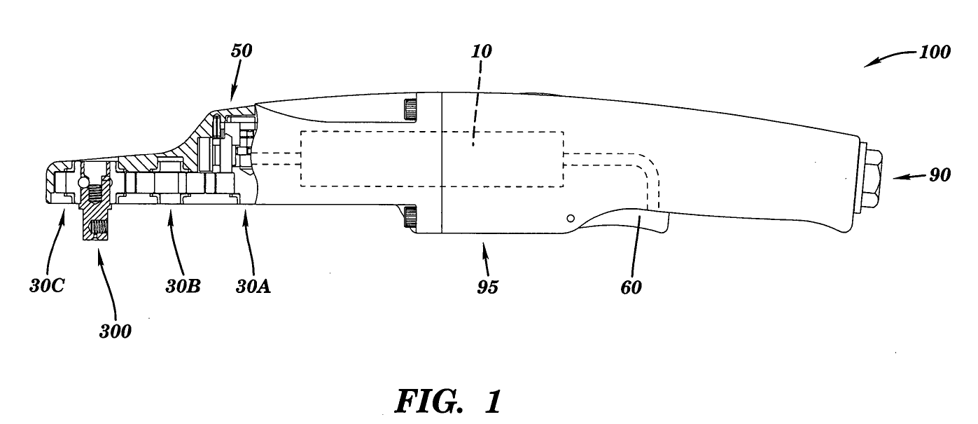

Referring to the drawings, FIG. 1 depicts a side view of a pneumatic ratchet wrench, denoted by a 100, in accordance with the present invention. The pneumatic ratchet wrench 100 includes a housing 95, a motor 10 therein, and a throttle 60, which is in communication with the motor 10. At one end of the housing 95 typically is a connector 90 for connecting the wrench 100 with an air source (not shown), such as an air compressor. At the distal end of the housing 95 is an anvil system 300, a ratchet and pawl system 50, and a plurality of offset gears 30 (e.g., 30A, 30B, 30C).

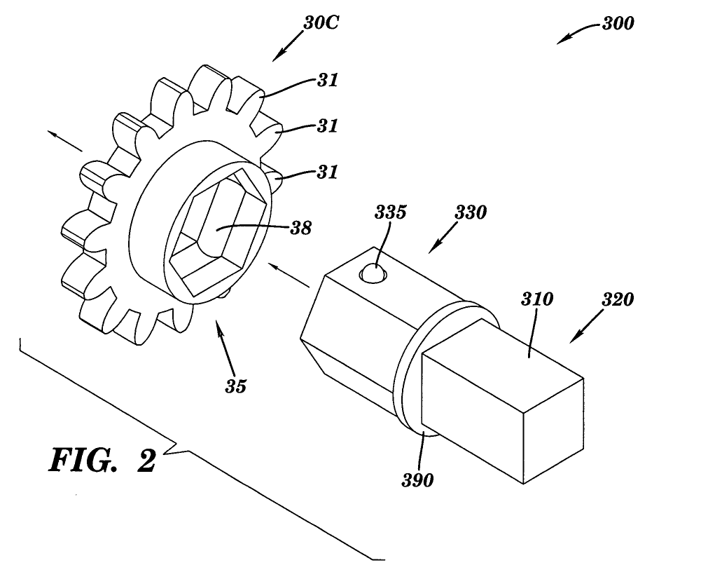

The ratchet and pawl system 50 allows for the switching of rotational direction of a rotating anvil 310 (See e.g., FIG. 2). Rotation of the motor 10 causes rotation of the plurality of offset gears 30 (e.g., 30A, 30B, 30C). Rotation of a first offset gear 30A causes rotation of a second offset gear 30B which, in turn, causes rotation of a third offset gear 30C. The third offset gear 30C being the most distal of the offset gears 30. The third offset gear 30C functionally interacts with the anvil system 300 so that rotation of the third offset gear 30C causes a similar rotation in the anvil 310 (See e.g., FIG. 2). It is the interrelationship, in part, between the third offset gear 30C and the anvil 310 that forms the anvil system 300 of the present invention.

Turning to FIG. 2 which shows the anvil system 300 in exploded perspective view and the interrelationship between the third offset gear 30C and the anvil 310. The third offset gear 30C include a plurality of teeth 31 interspersed on the outer circumference, which intermesh with like teeth on the second offset gear 30B. The anvil 310 includes a first end 320 and a second end 330. In the embodiment shown the first end 320 is square in cross-section, configured to receive typically a drive socket (not shown).

A coupling mechanism holds the anvil 310 to the offset gear 30. The coupling mechanism includes a ball 335 located on the anvil 310 and a detent 38 located on the offset gear 30. The entire coupling mechanism is self-contained within the anvil 310 and the offset gear 30. Thus, the coupling mechanism fully rotates in unison with the rotating anvil 310 and offset gear 30. This cuts down on the moving parts and minimizes additional bearing surfaces that are entailed in the coupling mechanism, thereby adding to the longevity of the device.

In the embodiment shown, the second end 330 is hexagonal in cross-section so as to correspond with a similarly shaped hexagonal axial opening 35 through the offset gear 30C. Located within the opening 35 in this embodiment the detent 38 is a detent ring 38 which communicates with a ball 335 located along the second end of the anvil 310. The detent ring 38 surrounds the entire circumference of the opening 35. This allows the anvil 310 to be placed within the gear 30 in virtually any rotatable configuration. The anvil 310 needs only to align with the shape of the opening 35 (e.g., hexagon, square, polygon, slotted, etc.). The anvil 310 slidingly engages with the gear 30 and locks into the gear 30 once the coupling mechanism is engaged. In the embodiment shown in FIG. 2, the anvil 310 is coupled, and locked, to the gear 30 (and thus the tool 100, in whole), once the ball 335 clicks into the detent 38.

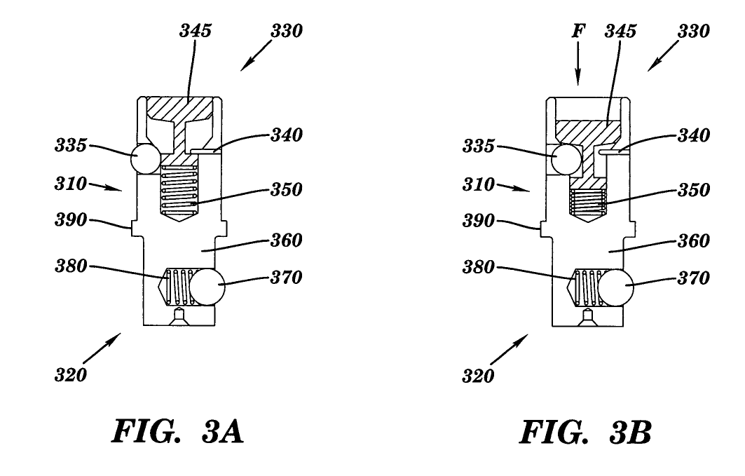

FIG. 3A depicts a side sectional view of an embodiment of the anvil 310. The anvil 310 includes a body 360 having a first end 320 which is used to attach to a additional drive, or bit (not shown) or directly interact with a workpiece (not shown) and a second end 330 housing a portion of a coupling and releasing mechanism of the anvil system 300. The first end 320 includes a ball 370, and a spring 380 to provide a bias against said ball 370.

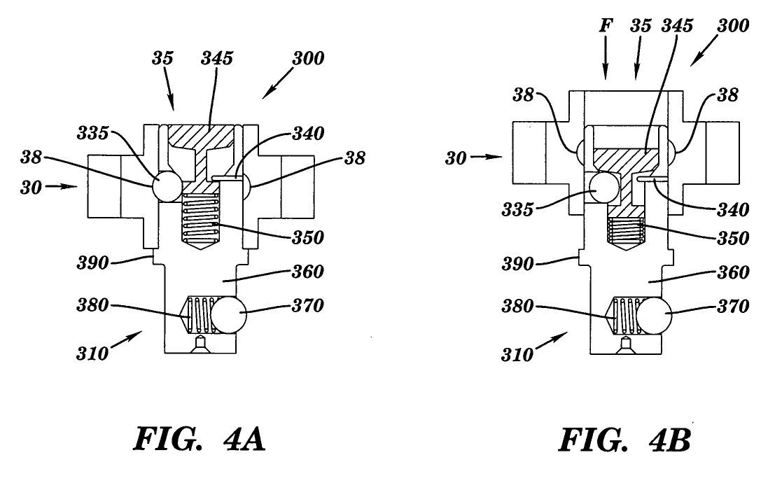

The second end 330 of the anvil 310 includes a portion of the coupling and releasing mechanism that includes a release button 345 functionally attached to the body 360 by a button retention pin 340. A spring 350 provides a bias against the release button 345, while an interior portion of the release button 345 provides a normal force against ball 335. The anvil 310 also has a collar 390 to allow for seating the anvil 310 against the third offset gear 30A (see FIGS. 4A and 4B). The release button 345, in the embodiment depicted, is coaxial with the anvil 310 and hourglass-shaped when viewed in section.

While the embodiment depicted shows the anvil 310 that has a first end 320 adapted to be an anvil 310 with a square drive (e.g., ¼″ drive) that typically receives a socket of various sizes. The present invention allows for the changing of the anvil 310 to anvils 310 having other configurations at the first end 320. For example, other sized (e.g., ⅜″, 1″, etc.) square drives for the anvil 310 may be used. Similar, instead of a square drive adapted to receive a socket, the first end 320 may also have other shapes. Other shapes of the first end 320 of the anvil 310 include screwdrivers (e.g., slotted, phillips, etc.), square recess, sockets, hexagonal, TORX®, spanner, clutch, tri-Groove, spline, and the like, or other shaped and sized bits.

FIG. 3B depicts a side sectional view of the anvil 310 (i.e., same view as FIG. 3A) only now with the release button 345 engaged, the spring 350 compressed, and ball 335 in a recessed position. The user presses, or engages, the release button 345 when they wish to remove, and change, the anvil 310 from the third offset gear 30A and tool 100, in general. The user can easily engage the release button 345, for example, by pressing the button 345 with their finger, or any small implement (e.g., pen tip, screwdriver, awl, etc.). When a force, designated by directional arrow F, is applied to the release button 345 that is greater than the upward force provided by the bias of the spring 350, the release button 345 is displaced further into the body 360. The maximum depth that the release button 345 can be displaced further into the body 360 of the anvil 310 is determined, in part, by the button retention pin 340. Thus, when the release button 345 is displaced by force designated by directional arrow F further into the body 360, the release button 345 no longer exerts a normal force against the ball 334. As a result, the ball 335 can recess into the body 360, and the anvil 310 can be removed from its seating.

FIG. 4A depicts a side sectional view of an anvil 310 coupled to an offset gear 30, thereby created an anvil system 300 in accordance with the present invention. The second end 330 of the anvil 310 resides within, and is coaxial with, the opening 35 of the offset gear 35. The seat 390 of the anvil 310 bears against, or abuts, the offset gear 30. The ball 335 rides within the detent ring 38 of the offset gear 30 thereby providing additional purchase between the anvil 310 and the offset gear 35.

FIG. 4B depicts a side sectional view the anvil system 300 (i.e., the view in FIG. 4A) further wherein the release button 345 has been pressed so that the anvil 310 is partially removed from the offset gear 30. As shown the release button 345 has been pressed downward, displaced by force designated by directional arrow F further into the body 360. As a result, the ball 335 no longer has a normal force applied to it by the lower body portion of the release button 345. This allows the ball 335 to recess into the body 360 of the anvil 310. Thus, the ball 335 no longer retains purchase with the detent ring 38 and the anvil 310 can easily, and quickly, be released from its seating within the offset gear 30.

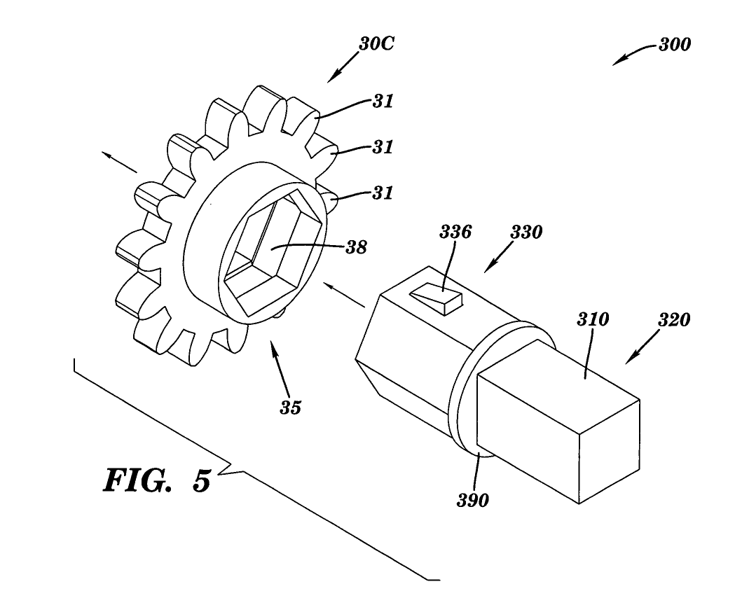

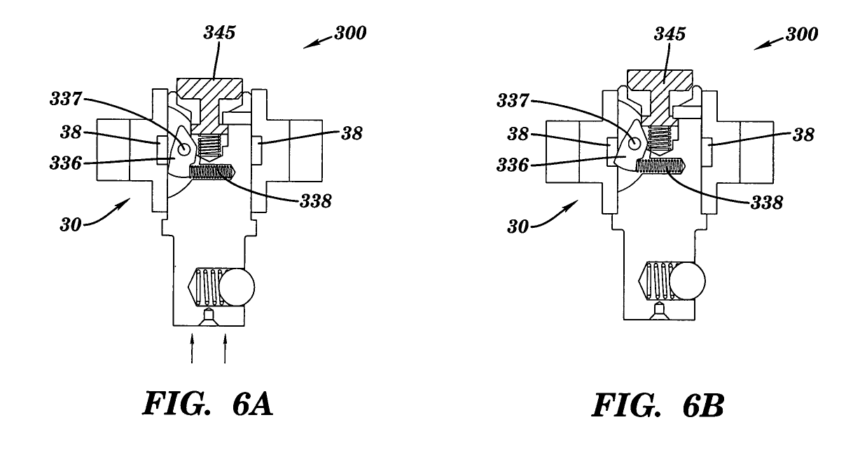

Turning to FIG. 5, which shows a second embodiment of the invention in the same perspective as depicted in FIG. 2, namely an exploded perspective view of the anvil 300 and its interplay with the offset gear 30C. The anvil 300, in this embodiment, employs as part of its coupling mechanism with the gear 30 a pawl 336. Another attribute of the second embodiment is that the release button 345 (see FIGS. 6A-6C) need not be pressed in order to install the anvil 310 and engage it to the gear 30. That is the release button 345 only needs to be employed (e.g., pressed) in order to release, disengage (i.e., change) the anvil 310 from the gear 30 and tool 100. Similarly though, the embodiment in FIG. 5 includes a coupling mechanism that is self-contained. Further, at least a portion of the coupling mechanism rotates along with the anvil 310.

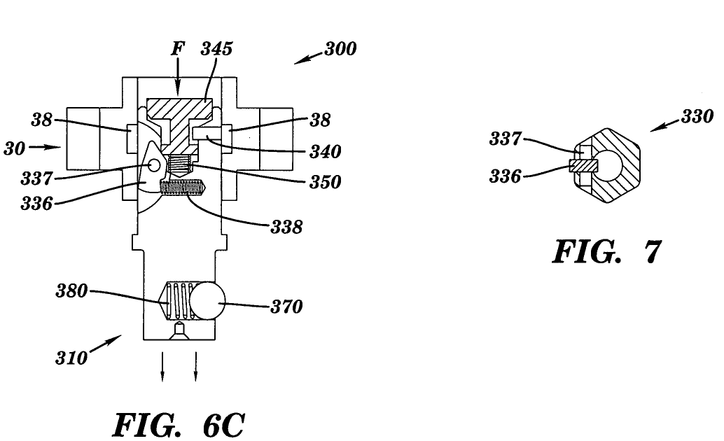

Turning to the side elevation sections shown in FIGS. 6A through 6C, the second embodiment's details will become more apparent. FIG. 6A depicts the anvil 310 as it is being pushed into releasable engagement with the offset gear 30. The pawl 336 rotates about a pin 337 (see FIG. 7) and is biased via a spring 338 which resides in a recess within the anvil 310. The shape of the pawl 336 is such that the anvil 310 may readily slide within the opening 35 of the gear 30. As can be seen in FIG. 6B, upon the successful mating of the anvil 310 and the gear 30, an anvil system 300 is created. The bias of the spring 338 exerts a lateral (i.e., outward) pressure on the pawl 336 such that the pawl 336 rotates into the detent 38. In this embodiment the cross section of the detent 38 may be rectangular, or square, so as to provide a better purchase for the pawl 336 against the gear 30.

Similar to the views shown in FIGS. 3B and 4B, the view in FIG. 6C shows the initiation of release of the anvil 310 from the gear 30. In order to remove the anvil 310, a force, denoted by directional arrow F, is exerted onto the button 345. As the button 345 is pushed further within the anvil 310, a bottom portion of the button 345 rides against the pawl 336 so that it rotates inward against the spring 338. As a result, the pawl 336 ultimately retracts within the body of the anvil 310 so that the pawl 336 no longer has purchase against the detent 38. The anvil 310 can then release from the gear 30.

While the embodiments shown includes some attributes, it should be apparent to those skilled in the art, that other variations, and embodiments are possible with the invention. For example, although a plurality of offset gear 30 are shown to ultimately carry the rotation of the motor 10 to the anvil 310, this is not necessary. A single gear (not shown) could be the interface between the motor 10 and anvil 310. Conversely, a different number of offset gears 30 could be provided. Similarly, differently mechanical interfaces entirely could be used between the anvil 310 and motor 10.

Similarly, although the detent ring 38 is shown within the offset gear 30, alternative retainment means (e.g., ball 335 and detent ring 38) may be used. For example, the detent ring 38 could be fixed within another portion of the tool 100 than the offset gear 30. Alternatively, instead of a detent ring 38, a detent point or detent slot (not shown) could be used to retain the ball 335.

Various modifications and variations of the described apparatus and methods of the invention will be apparent to those skilled in the art without departing from the scope and spirit of the invention. Although the invention has been described in connection with specific embodiments, outlined above, it should be understood that the invention should not be unduly limited to such specific embodiments. Various changes may be made without departing from the spirit and scope of the invention as defined in the following claims.

1. A rotatable anvil adapted for use with a pneumatic ratchet tool comprising:
an anvil having a coupling mechanism for releasable attachment of the anvil to said tool, wherein at least a portion of said coupling mechanism rotates along with said anvil.

2. The anvil of claim 1, wherein said coupling mechanism includes a ball configured to communicate with a detent.

3. The anvil of claim 1, wherein said coupling mechanism includes a pawl configured to communicate with a detent.

4. The anvil of claim 1, wherein a removal of said anvil from said tool can be activated by a user's finger.

5. The anvil of claim 1, wherein said coupling mechanism includes a button.

6. The anvil of claim 1, further including a first end configured to interact with a workpiece.

7. The anvil of claim 1, further including a first end configured to adapt to a socket piece.

8. The anvil of claim 2, wherein said detent is located on an offset gear.

9. The anvil of claim 3, wherein said detent is located on an offset gear.

10. The anvil of claim 1, wherein said coupling mechanism is self contained within said anvil and an offset gear within said tool.

11. An anvil system for use with a pneumatic ratchet wrench comprising:
a rotatable anvil, configured to be releasably attachable to said wrench; and
a coupling mechanism, for attaching and releasing said anvil from said wrench, said mechanism being self-contained.

12. A pneumatic ratchet wrench comprising:
a housing
a motor contained with said housing;
a plurality of offset gears in mechanical communication with said motor; and
a rotatable anvil releasably attached to at least one of said plurality of offset gears.

13. A method of using an anvil with a pneumatic ratchet wrench comprising:
providing a rotatable anvil;
releasably attaching said anvil to said tool, via a coupling mechanism, wherein at least a portion of said coupling mechanism rotates along with said anvil.
